(19) United States
(12) Patent Application Publication
(10) Pub. No.: US 2011/0253251 A1
(43) Pub. Date: Oct. 20, 2011

(54) NEEDLE GUIDE

(75) Inventor: Christopher S. MUDD, Goleta, CA (US)

(73) Assignee: ALLERGAN, INC., Irvine, CA (US)

(21) Appl. No.: 13/028,947

(22) Filed: Feb. 16, 2011

Related U.S. Application Data
(60) Provisional application No. 61/324,430, filed on Apr. 15, 2010.

(51) Int. Cl. A61J 1/20; B65B 3/04

(52) U.S. Cl. 141/2; 604/415

(57) ABSTRACT

Needle guides are disclosed. An example needle guide includes a base; a housing configured to hold a container, the housing disposed on the base such that a longitudinal axis of the container is held at a first angle to vertical; and a syringe holder configured to guide insertion of a needle of a syringe into the container, the syringe holder disposed on the housing such that the syringe is inserted into the container at a second angle to the longitudinal axis of the container.

CROSS REFERENCE

This application claims the benefit of U.S. provisional patent application No. 61/324,430, filed Apr. 15, 2010, the entire disclosures of which are incorporated herein by reference.

### BACKGROUND

Injectable substances are routinely stored in containers, such as bottles or vials, before use. For instance, many injectable substances are stored in glass bottles which are closed with a cover having a piercable membrane. In order to perform an injection, a practitioner typically inserts the needle of a syringe into such a container and draws the substance into the body of the syringe using the syringe plunger. Often, using such a technique, the practitioner is unable to draw a significant quantity of the substance. For instance, depending on the particular container, when only a small volume of material remains in the container, it may spread out thinly over the bottom of the container making it difficult or impossible to draw with a needle. Given the difficulty involved in drawing it, this material may often be discarded along with the spent container. However, a significant volume of material may be wasted, which in some applications may be problematic.

For example, a number of procedures involve the injection of carefully controlled volumes of substances. For instance, some medical and cosmetic applications involve the injection of botulinum toxin, e.g. for the treatment of muscle spasm. In such applications a small amount of the toxin is carefully injected directly into the tissue to be treated. In order to perform such treatments effectively, it is necessary for medical practitioners to be able to accurately assess the quantity of material injected. However, if practitioners believe that the entire contents of a container have been injected, although a significant volume of medicine was actually discarded with the container, practitioners may routinely underestimate the quantity of material injected. In addition, such waste may also lead to other problems. For instance, some injectable substances may be very expensive, and wasted material may be significant financially. In addition, some substances may be dangerous, or easily abused, in which case it may be desirable to avoid discarding any significant volume of the substance.

### SUMMARY

Example embodiments may provide needle guides which may include a base; a housing configured to hold a container, the housing disposed on the base such that a longitudinal axis of the container is held at a first angle to vertical; and a syringe holder configured to guide insertion of a needle of a syringe into the container, the syringe holder disposed on the housing such that the syringe is inserted into the container at a second angle to the longitudinal axis of the container.

In some example needle guides, the container may be a medication vial.

In other example needle guides, the first angle may be configured to cause a liquid in the container to pool in a corner formed between a bottom of the container and a wall of the container. And in some example needle guides, the second angle may be configured to position a needle of at least a predetermined length in the corner when fully inserted.

In still other example needle guides, the base may be horizontal.

Some example needle guides may further include a plurality of feet disposed on the base and configured to support the needle guide on a surface. And in some example needle guides a distance which at least one of the feet extends away from the base may be adjustable.

In another example needle guide, the first angle may be in the range of 15 to 16 degrees.

In still another example needle guide, a magnitude of the first angle may be the same as a magnitude of the second angle.

In some example needle guides, the housing may include a housing body having an internal cavity, the internal cavity sized to hold the container, the housing body having a first opening configured to allow insertion of the container into the cavity, and a second opening positioned adjacent the syringe holder, and configured to allow the needle of the syringe to enter the cavity. And in some example needle guides, the housing body further includes a third opening configured to allow a user to push the container out of the cavity.

In other example needle guides, the syringe holder may further include an at least partially tubular holder body having a diameter sized to hold the syringe, a first end of the holder body disposed adjacent to the housing.

In still other example needle guides, the first opening may be positioned on a side of the housing body facing partially upward.

Some example needle guides may further include a first hinge attaching the housing to the base.

Other example needle guides may further include a second hinge attaching the syringe guide to the housing.

In some example needle guides, the base, the housing, and the syringe holder are a single unitary piece.

And some example needle guides may include an indication of a type of container for which the needle guide is to be used.

Other example embodiments may provide methods of filling a syringe, which may include disinfecting a container; loading the container into a needle guide, the needle guide having a housing configured to hold the container, with a longitudinal axis of the container at a first angle from vertical; inserting the needle of a syringe into the container through a syringe holder disposed on the housing such that the needle is inserted into the container at a second angle to the longitudinal axis of the container; and drawing a fluid from the container into the syringe.

In other example procedures, the first angle may be in the range of 15 to 16 degrees.

Some example procedures may include leveling the needle guide.

In yet other example procedures may include adjusting the first angle.

Some example procedures may include selecting the needle guide from a plurality of needle guides based on the container.

And in some example procedures, the container may be a medication vial.

### BRIEF DESCRIPTION OF THE DRAWINGS

The present description will be more readily understood from a detailed description of example embodiments taken in conjunction with the following figures:

FIG. 1 illustrates an example needle guide in accordance with an example embodiment.

FIG. 2 illustrates an example needle guide in accordance with an example embodiment.

FIG. 3 illustrates a cross-sectional view of an example needle guide in accordance with an example embodiment.

FIG. 4 illustrates an example procedure in accordance with an example embodiment.

### DETAILED DESCRIPTION

As explained above, a number of medical, cosmetic, and other procedures, involve the injection of substances. Often these injectable substances, e.g. medicines, are stored in a container before injection, such as in a vial or bottle. In order to perform an injection the needle of a syringe may be inserted into the container, e.g. by piercing through a membrane which seals the container. The contents of the container may then be drawn into the syringe, and injected into a patient.

In some applications, it is important to use as much of the contents of a container as possible. For example, in some applications the substance itself may be quite valuable. Disposing of a small amount of such a substance along with an otherwise exhausted container may be wasteful and very expensive. In addition, some applications require accurate dosing, e.g. medical and cosmetic procedures involving the injection of small quantities of botulinum toxin. In performing such procedures, it may be important for a practitioner to know as nearly as possible the total volume of material which has been injected. Accordingly, in such applications, it may be important for the practitioner to draw and inject all or nearly all of the medicine in a particular container. To the extent some of that medicine is inaccessible, for example, the practitioner may believe the full contents of the container have been used to treat a patient, while, in fact, some of the container's contents failed to be injected.

However, it is often a difficult task to draw as much material as possible from a bottle using a syringe and needle. When only a small amount of material remains in a container, drawing the contents into a syringe generally involves accurately positioning the container so that its contents pool in an accessible location, and simultaneously, accurately positioning a needle in the pooled contents to draw them. Performing such a procedure may require considerable patience and skill, and often some material may be discarded with a container that could have been drawn had the container and needle been positioned optimally.

Accordingly, example embodiments provide systems and methods which may enable medical practitioners and others to efficiently use injectable material stored in a container. For instance, some example embodiments may provide a needle guide which may be designed to hold a container at an angle which allows material in the container to pool in such a way that it may be maximally extracted. In order to do so, the needle guide may hold the container in a predetermined position relative to the Earth's gravity, i.e. relative to vertical.

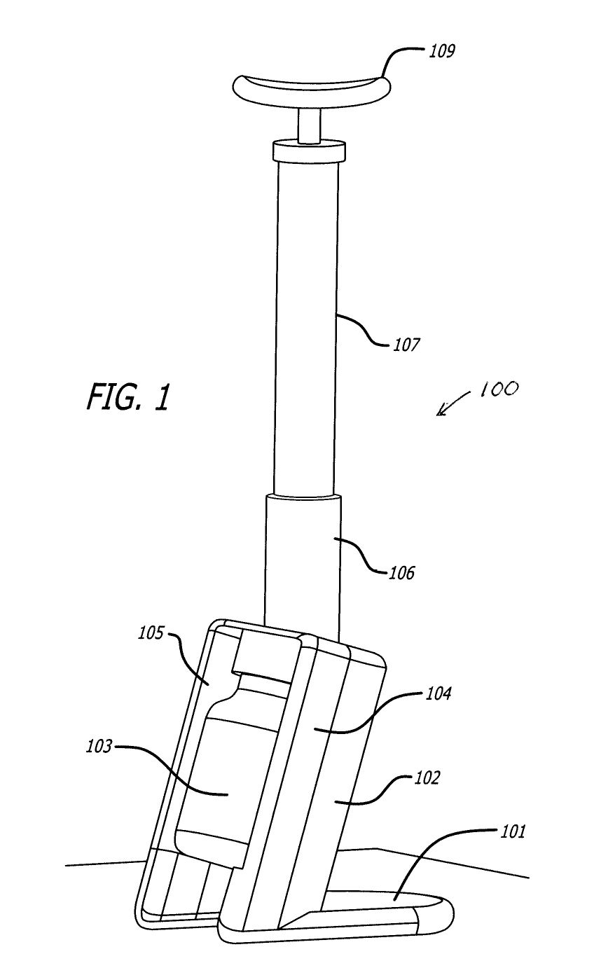

For example, FIG. 1 illustrates an example needle guide in accordance with an example embodiment. As illustrated, some example embodiments may include a base 101 which may rest on a fixed horizontal surface, e.g. a table, floor, etc. The base 101 may be designed to rest stably on a flat surface. Because tables and other common horizontal objects are often not level, however, some example embodiments may include an adjustment mechanism, which may allow a user to level the needle guide 100 once it is placed on a surface. For instance, an example needle guide 100 may include adjustable feet projecting downward from the base 101, on which the needle holder may rest. Any number of feet may be provided, e.g. three or four feet. In addition, at least one of those feet may be adjustable, in that a user may control the distance each foot extends away from the base 101, e.g. the feet may be threaded into the base 101 with a threaded shaft which may be adjusted by rotation, or the feet may be attached to the base 101 by a shaft held in place by friction or detents which may be adjusted in and out, etc. The feet may be independently adjustable, allowing a user to level the needle guide 100 by adjusting one foot at a time until the needle guide 100 is level. To facilitate this adjustment, some example embodiments may include leveling aids. For instance, an example needle guide 100 may include one or more levels, e.g. bubble levels or other kinds of levels, which may indicate the amount by which the needle guide's 100 current orientation deviates from level. For example, some example embodiments may provide two levels, which may allow a user to orient the needle guide 100 properly.

Other example needle guides 100 may be designed to attach to other types of surfaces. For instance, some example needle guides 100 may be designed to attach to a wall, e.g. having a vertically oriented base 101 which may be screwed into a wall, or otherwise affixed to a wall. Still other embodiments may be designed to attach to other objects. For instance, some example needle guides 100 may be designed to attach to tubing, and may provide a base 101 having straps which may be drawn around the tubing. Any other suitable base 101 may be provided.

Attached to the base 101 may be a container holder. For instance, as illustrated, some example embodiments may provide a housing 102 shaped to hold a container 103. The housing 102 may be constructed in any form capable of holding a container 103. For instance, the housing 102 may be substantially cylindrical, having an internal cavity sized and shaped to hold a container 103. In some examples, one end of the housing 102 may be attached to the base 101, while another may have an opening into which a needle may be inserted. The housing 102 may take other forms as well. For instance, the housing 102 may be rectangular, or may have another appropriate shape. In addition, in some example embodiments the housing 102 need not have an internal cavity at all. Rather, the housing 102 may simply include a support rod, or other support structure, which may allow for the mounting of the container 103. For instance, a support rod may be provided which may include straps, clips, or other fasteners which may be designed to hold a container 103.

As illustrated, the housing 102 may be designed to hold a container 103 in an inclined position relative to vertical. By holding the container 103 in such a position, the medicine, or other substance, in the container 103 may be caused to pool in a portion of the container 103 from which it may be easily extracted. It is noted that material may generally be extracted from some portions of a container 103 more easily than others. Specifically, if the material is spread thinly over a large surface area, it may be more difficult to draw, while if it is pooled together in a deep narrow area it may be easier to extract. The optimal such area may differ from container to container, based on the structure of the container. Often, e.g. in the case of a bottle or vial having a generally flat bottom, the contents of the container may be most easily drawn if they are pooled along a corner where the bottom of the container meets a wall of the container. It is also noted that, in many such containers, the contents will spread thinly across the relatively large bottom of the container if the container is held vertically.

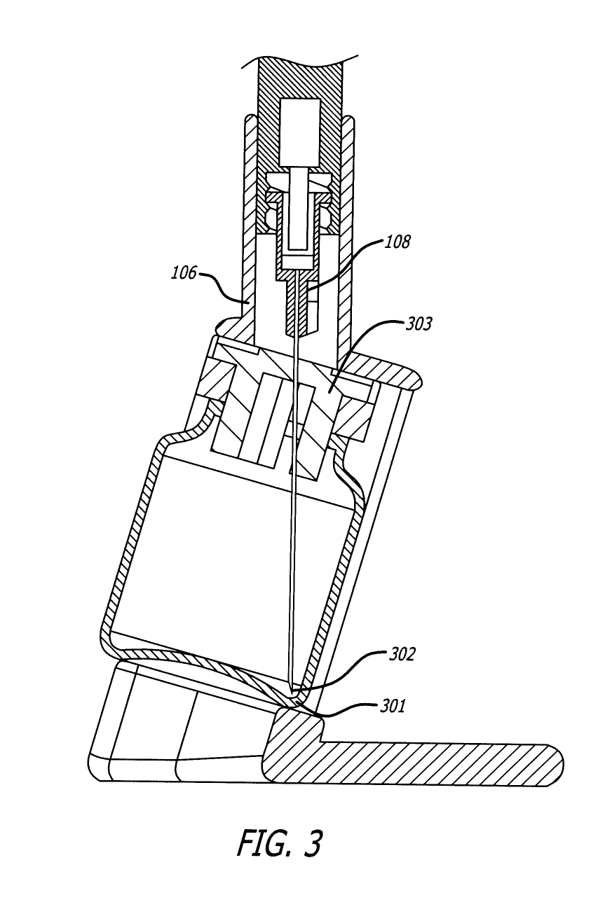

Accordingly, the housing 102 may be attached to the base 101 such that, when a container 103 is inserted in the housing 102, the container 103 is held at an angle to vertical which causes the contents of the container 103 to pool in a favorable location. For example, FIG. 3 illustrates a container 103 held at an angle by a needle guide. The contents of the container 103 will tend to pool in the lowest portion of the container 103, here the area 301. Because the structure of the container 103 determines the ideal angle, some example needle guides 100 may be configured for use with particular containers 103. For instance, some example needle guides may be constructed with bases 101 and housings 102 which fit a particular container 103 and hold that container 103 at a predetermined angle to vertical. For example, a needle guide may be configured for use with a standard Botox 100U vial. In such a case, the angle at which the container 103 is to be held may not vary, as each container 103 used in the needle guide 100 may be of similar construction. For instance, in some applications, the angle at which the container 103 may be held may be in the range of 15 to 16 degrees.

Some such example needle guides 100 may carry an indication of the container with which they are intended for use. For example, the illustrated example has a marking 104 indicating that the needle guide 100 is intended for use with a Botox 100U container. The indication itself may be formed in any way. For example, it may be engraved, molded, or adhered as a sticker, etc. In addition, the indication may identify a container 103 or set of containers in any reasonable way. For instance, the indication may provide a size, or model number, common name, etc. of a container 103. In some embodiments, the needle holder 100 may be color coded to identify the intended container 103. For instance, if three types of containers 103 are in use, those containers 103 may be assigned a color, and may possibly even bear that color. Corresponding needle holders 100 may also be labeled with the color. In some examples, the needle holder 100 itself may be the color, e.g. being formed of blue or green plastic, etc.

Other example embodiments may be adjustable, allowing a user to select the angle at which a container 103 will be held. For example, the housing 102 may be attached to the base 101 with a hinge, which may allow selection of the angle between the housing 102 and the base 101. The hinge may be of any construction. For instance, the housing 102 may be attached to the base 101 with one or more pins, around which the housing 102 may be free to rotate, or may be attached with a living hinge, etc. Such example embodiments may also contain a positioning device to hold the housing 102 in the selected angle. This device may be part of the hinge, e.g. the hinge may be a friction hinge which may hold the housing 102 in a selected position unless a frictional force is overcome, or the hinge may include detents, tensioning hardware, etc. Other embodiments may provide a mechanism distinct from the hinge. For example some embodiments may provide a slider or an extendable bar support extending between the housing 102 and the base 101, which may hold the housing 102 in a position using friction, detents, locking hardware, etc. Some embodiments may also have angle indicators, e.g. markings, allowing a user to read the currently selected angle.

The housing 102 may include an opening 105 into which the container 103 may be inserted. For instance, the housing 102 may have an opening 105 on one side, into which a container 103 may be fit. The opening 103 may be located on a side of the housing 102 which faces partially upwards, due to an angle with which the housing 102 is attached to the base 103. This position of the opening 105 may serve to keep the container 103 in place once it is fit into the housing 102. In some example embodiments, this opening 105 may be shaped to ensure a particular orientation of the container 103. For instance, the opening 105 may have tabs or keys designed to engage the container 103, allowing the container 103 to enter the housing 102 only when it is inserted in an appropriate orientation relative to the housing 102. Such an opening 105 may allow the needle guide 100 to be used with containers 103 which are not symmetrical about a vertical axis. Example embodiments may include other features as well. For instance, some embodiments may include a door which may be closed over the opening 105, holding the container 103 in place. Other examples may include compressible material disposed inside the housing 102, or flexible arms, clips, straps, etc., which may fit a container 103 snugly when inserted, holding it securely in place.

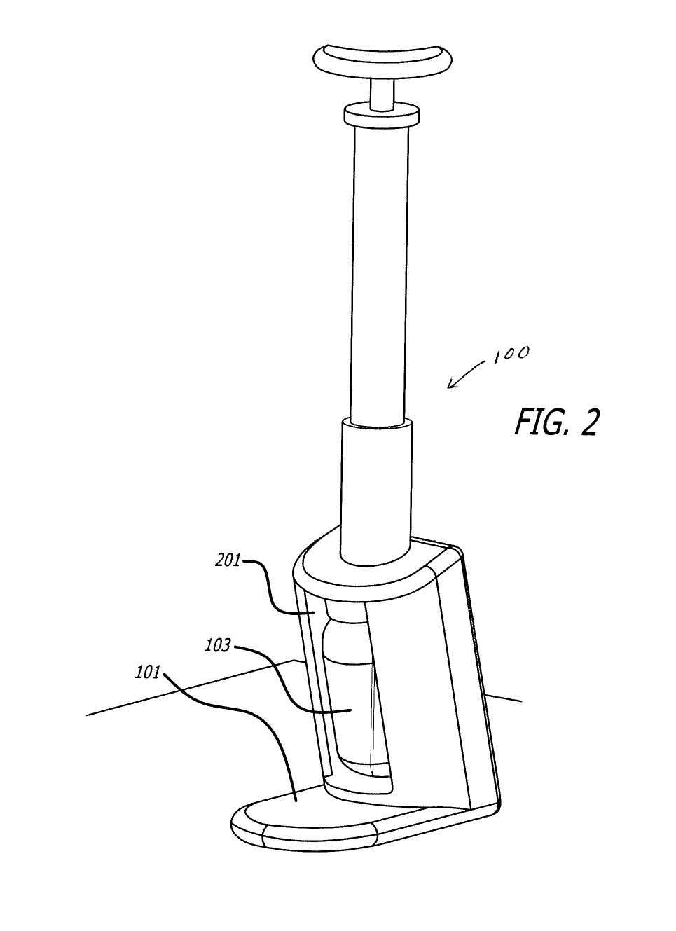

Some example housings 102 may also contain a second opening 103. For example, a second opening 201 can be seen in FIG. 2, which illustrates an example needle guide 100 from another viewing angle. The second opening 201 may allow a user to easily view the container 103 during use. For instance, the second opening 201 may allow the user to view the container 103 directly and may also allow light to enter the housing 102. Further, the second opening 201 may be located opposite the first opening 105 and may be sized such that a user may easily push the container 103 out of the housing 102 once the container 103 has been used. Further, the second opening 201 may be small enough to prevent the container 103 from passing through the second opening 201, and possibly falling out of the needle guide 100. Other embodiments need not include a second opening 201, however. In such embodiments, the ability view and eject the container 103 may be provided for in other ways, or not at all. For instance, in some example embodiments the housing 102 may be constructed of a transparent material which may allow the user to view the container 103 during use. Further, some example embodiments may provide a lever or arm attached to the housing 102 which may eject the container 103. For example, a lever or arm may apply a force to the container 103 tending to push it out of the opening 105 in response to a user pressing a button which may be mounted on the outside of the housing 102, etc.

Further, example embodiments may also include a syringe holder 106. The syringe holder 106 may be attached to the top of the housing 102 and may be in form of, e.g., a tube, a partial tube, a support with guide rings, or any other form capable of holding a syringe. For instance, the syringe holder 106 may be a tube sized and shaped to hold a standard syringe 107 securely. The syringe holder 106 may be open on one end, allowing a user to insert a syringe 107, needle 108 first, into the needle guide 100. The other end of the syringe holder 106 may attach to and may open into the housing 102. For instance, the syringe holder 106 may be positioned on the top of the needle holder 100 such that a syringe 107 may be inserted into the syringe holder 106 in a downward position, and such that when the syringe 107 is pushed into the syringe holder 106, the needle 108 enters into the housing 102, and into the container 103, e.g. piercing through a membrane sealing the container 103.

The angle at which the needle 108 enters the container 103 may be controlled by the angle at which the syringe holder 106 is oriented with respect to the housing 102. As illustrated, because the container 103 is held at an angle to vertical, its contents will have pooled, e.g. somewhere along an edge of the base of the container 103. In order to extract the maximum amount of the substance, the needle 108 must be pushed to the same place, which generally means that the needle 108 will have to enter the opening of the container 103 at an angle. Accordingly, the syringe holder 106 may be attached at an angle such that the needle 108 is guided to the intended location within the container 103, when it is inserted. For example, referring to FIG. 3, a syringe holder 106 may be configured to hold a syringe 107 in a position which directs the needle 108 of the syringe 107 into the lowest area 301 of the container 103, in which the contents of the container 103 may have pooled. As seen in the figure, the tip 302 of needle 108 is guided to the lowest area 301 of the container 103. Also as seen, in order to properly place the tip 302 of the needle 108, the syringe holder 106 may be oriented such that the needle 108 enters the container 103 at an angle to the top 303 of the container 103.

In some example embodiments, the angle with which the syringe holder 106 is attached to the housing 102 may be fixed. For instance, in needle guides 100 designed to work with a particular container 103, the angle may be chosen to meet the needs of the particular container's 103 configuration. In such embodiments, the syringe holder 106 and the housing 102 may be formed of a single unitary piece of material.

In other embodiments, the angle may be adjustable. For instance, the syringe holder 106 may be hinged to pivot. In particular, the syringe holder 106 may be hinged such that it is able to rotate in the same plane in which the housing 102, of an adjustable angle housing 102, is able to pivot. Again, the hinge may be constructed in any suitable material and in any reasonable way, e.g. pins, a living hinge, etc. Further, as above, the syringe holder 106 may include a mechanism to hold it in place once adjusted, e.g. a friction hinge, detents, an adjustable support rod or slider between the syringe holder 106 and housing 102, tensioning hardware, etc. Further, an angle guide may also be provided which may allow a user to read off and select a desired angle.

It is noted that, depending on the configuration of the container 103, it will generally be desirable for the needle 108 to be held vertically. Accordingly, the syringe holder 106 may be oriented with the same angle to the container 103 as the container 103 forms with vertical (although in the opposite direction). In adjustable embodiments including angle guides, a user may easily configure the needle guide 100 into such a configuration, as once the housing 102 is positioned appropriately, the angle of the housing 102 may be read off and the angle of the syringe holder 106 may simply be set to match it. In some example embodiments, the adjustment mechanisms may be linked, such that elements of the needle guide 100 adjust together.

Further, the syringe holder 106 may be sized to accommodate a particular syringe 107 or range of syringes. Alternatively, the syringe holder 106 may include a clamping mechanism which may accommodate a range of syringes 106. In particular, some example needle guides 100 may allow for the use of syringes 107 with different diameters. For example, the syringe holder 106 may have an inner lining of compressible material which surrounds, or partially surrounds, the syringe 107 when it is inserted. In other embodiments, the syringe holder 106 may include a clamping mechanism. For instance, two semicircular guides may be disposed within the syringe holder 106 which may be pushed toward the center of the syringe holder 106 by springs, or other mechanisms. A syringe 107 may then be inserted between the two elements, which may expand apart to accommodate the syringe.

The elements of the needle guide 100, e.g. the base 101, housing 102, and syringe holder 106, may be made of any reasonable material. For instance, they may be constructed of plastics, metals, glass, composite materials, elastomers, rubber, etc. In addition, each of the pieces may be made of different materials or the same material, and may be formed together in a single piece, or separately, as distinct pieces, etc. Further, they may be constructed using any reasonable process. For instance, they may be cast, molded, stamped, cut from a blank, etc.

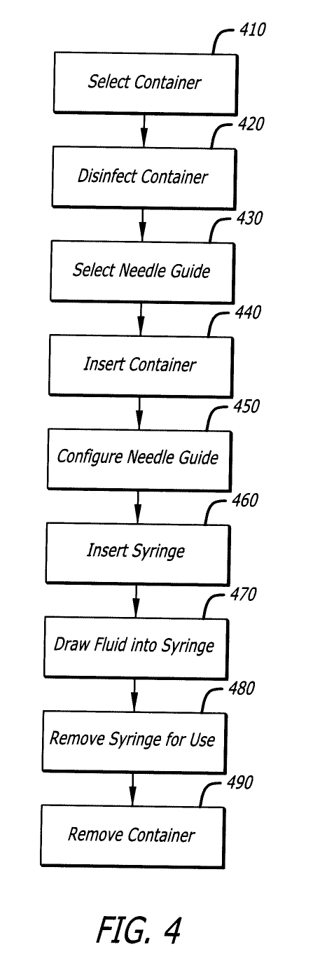

Other example embodiments may also provide procedures for filling a syringe using a needle guide. For instance, an example procedure is illustrated in FIG. 4. The example procedures may begin, at 410, with the selection of a container holding a substance to be injected. For instance, in an example application a Botox 100U container might be selected. Once the container is selected (and otherwise prepared as necessary), the container may be disinfected, at 420, e.g. the container may be wiped with an alcohol swab, or other disinfectant.

At 430, a needle guide, such as one of the example needle guides described above, may then be selected. For instance, the needle guide may be selected to match the specific container being used, such as, e.g. a Botox 100U container. In other embodiments, an adjustable needle guide may be selected.

At 440, the container may then be inserted into the needle guide. For instance, the container may be pushed through the opening and into the housing. Should the needle guide have a mechanism to secure the container, e.g. a door to the opening, the container may be secured.

At 450, the needle guide may be leveled on a surface. For instance, the needle guide may be placed on a table. If the needle guide chosen has a level adjustment mechanism, the level of the needle guide may be adjusted. For instance, the height of feet attached to the base may be adjusted until the needle guide rests in a level orientation. In addition, if the needle guide permits, the angle at which the container is held may be adjusted, along with the angle at which a needle is guided into the container, as appropriate given the design of the selected container.

Once the needle guide is selected and configured, at 460, a syringe may be inserted into the container. Here the syringe may be inserted, needle first, into the syringe holder of the needle guide. The syringe may then be pushed forward into the syringe holder, until the needle is properly positioned. As the syringe is moved forward, the needle may enter the container, e.g. piercing through a membrane covering the container, and may continue forward until it is located in an area of the container in which the contents of the container have pooled.

Holding the syringe in place, at 470, the plunger of the syringe may then be pulled away from the needle, drawing the contents of the container into the syringe. Once the desired quantity of material has been drawn, or the container exhausted, at 480, the syringe may be removed from the needle guide, and used to inject a patient.

After use, at 490, the container may be removed from the needle guide. For instance, the container may be pushed out of the housing, e.g. by applying a force to the container through an opening in the housing of the needle guide. The container may then be discarded, reused, or stored as appropriate, and the needle guide may be ready for repeated use.

In the preceding specification, the present invention has been described with reference to specific example embodiments thereof. It will, however, be evident that various modifications and changes may be made thereunto without departing from the broader spirit and scope of the present invention. The description and drawings are accordingly to be regarded in an illustrative rather than restrictive sense.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A needle guide, comprising:
a base;
a housing configured to hold a container, the housing disposed on the base such that a longitudinal axis of the container is held at a first angle to vertical; and
a syringe holder configured to guide insertion of a needle of a syringe into the container, the syringe holder disposed on the housing such that the syringe is inserted into the container at a second angle to the longitudinal axis of the container.

2. The needle guide of claim 1, wherein the container is a medication vial.

3. The needle guide of claim 1, wherein the first angle is configured to cause a liquid in the container to pool in a corner formed between a bottom of the container and a wall of the container.

4. The needle guide of claim 3, wherein the second angle is configured to position a needle of at least a predetermined length in the corner when fully inserted.

5. The needle guide of claim 1, wherein the base is horizontal.

6. The needle guide of claim 1, further comprising:
a plurality of feet disposed on the base and configured to support the needle guide on a surface.

7. The needle guide of claim 6, wherein a distance which at least one of the feet extends away from the base is adjustable.

8. The needle guide of claim 1, wherein the first angle is in the range of 15 to 16 degrees.

9. The needle guide of claim 1, wherein a magnitude of the first angle is the same as a magnitude of the second angle.

10. The needle guide of claim 1, wherein:
the housing includes a housing body having an internal cavity, the internal cavity sized to hold the container, the housing body having a first opening configured to allow insertion of the container into the cavity, and a second opening positioned adjacent the syringe holder, and configured to allow the needle of the syringe to enter the cavity.

11. The needle guide of claim 10, wherein:
the housing body further includes a third opening configured to allow a user to push the container out of the cavity.

12. The needle guide of 1, wherein:
the syringe holder further includes an at least partially tubular holder body having a diameter sized to hold the syringe, a first end of the holder body disposed adjacent to the housing.

13. The needle guide of claim 10, wherein the first opening is positioned on a side of the housing body facing partially upward.

14. The needle guide of claim 1, further comprising:
a first hinge attaching the housing to the base.

15. The needle guide of claim 1, further comprising:
a second hinge attaching the syringe guide to the housing.

16. The needle guide of claim 1, wherein the base, the housing, and the syringe holder are a single unitary piece.

17. The needle guide of claim 1, further comprising:
an indication of a type of container for which the needle guide is to be used.

18. A method of filling a syringe, comprising:
disinfecting a container;
loading the container into a needle guide, the needle guide having a housing configured to hold the container, with a longitudinal axis of the container at a first angle from vertical;
inserting the needle of a syringe into the container through a syringe holder disposed on the housing such that the needle is inserted into the container at a second angle to the longitudinal axis of the container; and
drawing a fluid from the container into the syringe.

19. The method of claim 18, wherein the first angle is in the range of 15 to 16 degrees.

20. The method of claim 18, further comprising:
leveling the needle guide.

21. The method of claim 18, further comprising:
adjusting the first angle.

22. The method of claim 18, further comprising:
selecting the needle guide from a plurality of needle guides based on the container.

23. The method of claim 18, wherein the container is a medication vial.
